(19) United States
(12) Patent Application Publication
(10) Pub. No.: US 2001/0045753 A1
(43) Pub. Date: Nov. 29, 2001

(54) Combined spatula and tong device for cooking

(76) Inventor: Davidson W. Lewis, Virginia Beach, VA (US)

Correspondence Address: KIMBERLY A CHASTEEN, WILLIAMS MULLEN CLARK & DOBBINS, ONE IOD OYSTER POINT ROAD, SUITE 210, NEWPORT NEWS, VA, 23602

(21) Appl. No.: 09/862,646

(22) Filed: May 22, 2001

Related U.S. Application Data
(60) Provisional application No. 60/206,680, filed on May 24, 2000.

(51) Int. Cl. A47J 43/28

(52) U.S. Cl. 294/3

(57) ABSTRACT

An improved cooking device may be used as a spatula or as tongs. The device has upper and lower jaws which are connected to a handle. The handle is spring biased such that the upper and lower jaws are in substantially parallel contact with each other and such that a compression force on the handle causes the upper and lower jaws to separate from each other.

### CROSS REFERENCE TO RELATED APPLICATION

The present application claims priority from U.S. Provisional Application Ser. No. 60/206,680 filed May 24, 2000.

### FIELD OF INVENTION

This invention relates to cooking tools used to control and handle food while cooking in a pan or on a grill. More specifically, this invention relates to a tool that will substantially improve control, safety, and comfort while cooking food.

### BACKGROUND OF INVENTION

Cooking spatulas are commonly used when preparing food in a pan or on a grill. They provide the user with a tool to scoop, flip, stir, and serve food. Because of their size and shape, scooping, flipping, and serving certain foods can be difficult, impossible, and even dangerous.

Another popular tool used to cook food is a pair of cooking tongs. Cooks usually have a pair of tongs handy to grab, flip, and serve the food. While this is safer and easier than using a spatula since the tongs actually grab the food, using tongs can tear or make food fall apart when trying to flip or serve. The food could also fall from the tool causing damage to the food or harm to the cook. Most kitchens have a spatula and pair of tongs handy. These are most likely switched back and forth to do similar jobs while cooking. After preparing the meal, a spatula and or a pair of tongs can be found on the dinner table used to serve the food.

Having a tool that is easy to use, effective, and safe is important when cooking. If the tool does not function well or is not effective, the cooking will suffer. If the tool is unsafe, the cook could be injured. A tool that provides increased control, safety, and comfort will be very beneficial to a cook.

### DESCRIPTION OF RELATED ART

One type of popular kitchen tool used to handle food is described in U.S. Pat. No. 3,758,143. Cooking spatulas of this shape and similar shapes have a thin flat head, a bent neck, and a handle. The thin head is used to scoop under the food. Most spatulas have perforated heads that allow liquids to pass through. A cooking spatula's bent shape allows for more ergonomic and efficient use. The length of the handle provides safety and leverage when handling food.

A problem associated with this prior art is that it is often difficult to scoop, grab, flip, drain, and serve certain types of food. When there is a small amount of food in a pan a spatula tends to push food around the pan. If the pan is overly full, a spatula tends to push food out of the pan. In both instances it is difficult to control the food. After the spatula head is pushed under the food, food can be flipped. Many times this is a difficult task due to the weight or shape of the food. Flipping with a spatula can cause splashing when cooking in liquids, which can be very dangerous and lead to damaging bums. Furthermore, if draining excess liquid is desired, a spatula is not very effective since the liquid can only drain off the bottom through the holes. Another disadvantage occurs when serving from the pan or grill, a spatula easily drops food since the food is only resting on top of it.

Another type of popular cooking tool used to handle food is described in U.S. Pat. No. 5,934,721. Tongs of this shape are composed of a piece of metal bent in a “C” shape which acts as a spring and connects to the jaws of the tongs. At the ends of this “C”, the tongs have toothed jaws that provide a better hold. The shape of the “C” acts as a spring to keep these jaws open. To close the jaws the “C” shape is compressed inwards.

As disclosed in U.S. Pat. No. 5,601,323 a tong may have a scissor like joint. To operate a tool such as this, one simply compresses the handles to make the jaws close. One problem with these types of tongs is that they tend be damaging to food by gripping too tightly on a small area of food and either distort or tear the food. Another problem is that tongs are awkward and uncomfortable to use. In situations when a spatula is not doing a good job, a pair of tongs is used. This causes the problems of having to find, use, clean, and store extra tools when a spatula does not suffice.

Moreover, in order to hold food with tongs, constant pressure must be applied to the handle. This can be uncomfortable. Along with its other disadvantages, the cook ends up having to use multiple tools for similar jobs. Swapping these tools back and forth while cooking may cause confusion and frustration. Other problems associated with using both tools include issues of control, safety, and comfort while cooking.

### SUMMARY OF THE INVENTION

An improved cooking device is described. The device has upper and lower jaws. A handle is connected to one end of each jaw and connects the jaws to each other. The handle is spring biased such that the upper and lower jaws are in substantially parallel contact with each other and such that a compression force on the handle causes the upper and lower jaws to separate from each other. The jaws are generally planar in configuration. The jaws and handle are generally made from a heat resistant material or coated with a heat resistant coating as is common with this type of cooking instrument. The jaws may include drainage holes of any number and configuration. The forward portion of either or both of the jaws may be divided into tines and each jaw may remain planar in configuration or the jaws may be in contact only at the end and curve away from each other in the central portions of the jaws.

An object of the invention is to provide an improved cooking tool.

Another object of the invention is to provide an improved cooking tool which is safe and convenient to use.

Yet another object of the invention is to provide a combined cooking spatula and tong device.

A further object of the invention is to provide an improved cooking device which is inexpensive to manufacture.

Finally, it is an object of the present invention to accomplish the foregoing objectives in a simple and cost effective manner.

### BRIEF DESCRIPTION OF THE DRAWINGS

FIG. 1A is front perspective view of a prior art tool.

FIG. 1B is front perspective view of a prior art tool.

FIG. 2 is a front perspective view of type of tool of the present invention with its jaws closed.

FIG. 3 is a front perspective view of type of tool of the present invention with its jaws opened.

FIG. 4 is a plan view of tool in FIG. 2.

FIG. 5 is an underside plan view of tool in FIG. 2.

FIG. 6 is a side elevation of the tool in FIG. 2 with its jaws closed.

FIG. 7 is a side elevation of the tool in FIG. 3 with its jaws opened.

FIG. 8 is a front elevation of the tool in FIG. 2 with its jaws closed.

FIG. 9 is a front elevation of the tool in FIG. 3 with its jaws opened.

FIG. 10 is a front perspective of the preferred version of the present invention in use with closed jaws.

FIG. 11 is a front perspective of the preferred version of the present invention in use with the jaws holding the food.

FIG. 12 illustrates a further embodiment of the present invention.

FIG. 13 illustrates a further embodiment of the present invention.

FIG. 14 illustrates a further embodiment of the present invention.

FIG. 15 illustrates a further embodiment of the present invention.

FIG. 16 illustrates a further embodiment of the present invention.

FIG. 17 illustrates the present invention in use in the resting position.

FIG. 18 illustrates the present invention in use in the compressed position.

### DETAILED DESCRIPTION OF THE DRAWINGS

The present cooking device invention increases control, comfort, and safety while cooking. When the cooking device is used, it provides the cook with better functions than previously found in cooking tools.

This improved cooking device offers multiple functions for handling food. It can be used as a cooking spatula, among other things. For example, all functions accomplished by a spatula are available when the device is in the spatula like position. One can stir, scoop, flip, and serve as if they were using a regular cooking spatula. However, instead of having one head like a conventional cooking spatula, this cooking device has two jaws. One jaw is pressed against the other in its normal resting position. Unlike a conventional cooking spatula, the handle of this cooking device can be compressed to open the two jaws.

When the handle is squeezed the spatula like head opens into two jaws. The top jaw is connected to the bottom of the “C” shaped handle, while the bottom jaw is connected the top of the “C” shaped handle. The handle keeps the top jaw pressed against the bottom jaw when there is no pressure on the handle and the jaws remain in the spatula like position when the device is in the resting position. Applying pressure to the handle makes the neck of the top jaw move past the neck of the bottom jaw, thus spreading the jaws open. To grab food, the jaws are opened by applying pressure to the handle and the bottom jaw is slid under the food. When pressure on the handle is released, the jaws clamp down on the food. This allows the user to have better control over the food. The jaws open and close substantially parallel to one another. This grips the food evenly and does not distort the shape of the food. To release the food, the user simply reapplies pressure to the handle which causes the jaws to open. This design allows the user to hold food in the jaws without having to apply constant pressure. The spring action of the handle and friction hold the food in place.

Being able to grab the food allows one to move the food around the cooking surface efficiently, comfortably, and safely. If flipping of the food is needed, grabbing the food between the jaws allows for a very controlled and safe flip. When it comes time to serve the food, grabbing the food between the jaws provides an efficient, comfortable, and safe method of serving.

An alternate embodiment of this invention allows the user to interchange the upper jaw and the lower jaw. This is accomplished by moving the upper jaw out to the side and past the lower jaw. This then allows the upper jaw to become the lower jaw. In this arrangement, the jaws stay open in the resting position and are closed when the handle is compressed. This allows the user to employ the device in an alternate manner as a conventional pair of tongs. This arrangement also allows for easy cleaning.

Other alternate embodiments of this invention include wide upper and lower jaws, alternate handle designs, interchangeable jaws, an upper jaw which includes tines, and upper and lower jaws including tines which are slightly curved in opposite directions such that the tips are in contact but the remainder of the jaws curve away from each other.

When the jaws are closed, as is the case in its resting position, this cooking device functions much like a spatula. When the jaws are opened, the cooking device functions much like a pair of tongs. The device provides the user with better and more functions and benefits than a cooking spatula and a pair of cooking tongs. The device provides better control and comfort in addition to improving safety while cooking.

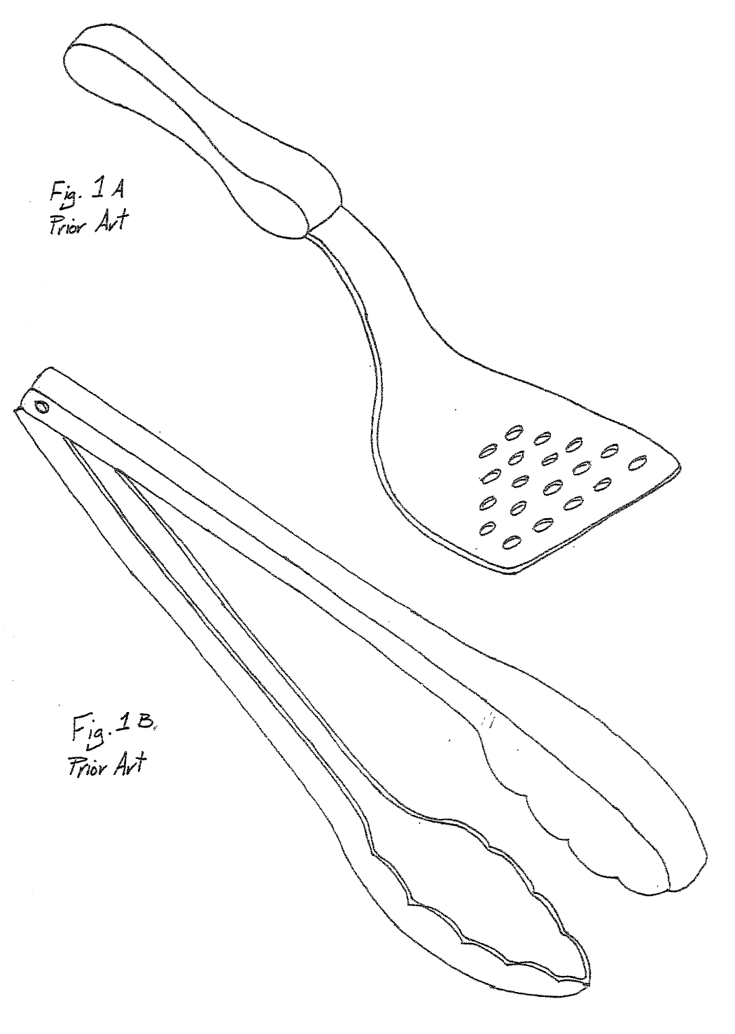

As shown in FIG. 1, the jaws are preferably approximately 3 inches wide and 4 inches long but can be smaller or larger depending on the particular use. For example, a version designed to flip an omelet would be shorter and wider while a version designed to flip a steak on a barbecue would be much larger. These jaws can also be in different shapes with different hole patterns or tines depending on the particular use. For example, a version designed to flip food while frying would have larger holes or tines to drain off excess grease or liquids, while a version designed to flip fish or other flaky foods would have no or a limited number or holes to hold the food together and juices in. The jaws can also be bent in different shapes depending on particular use. For example, a version designed to grab food while frying or toss salad would have jaws that curved and then tapered together to grab food easier.

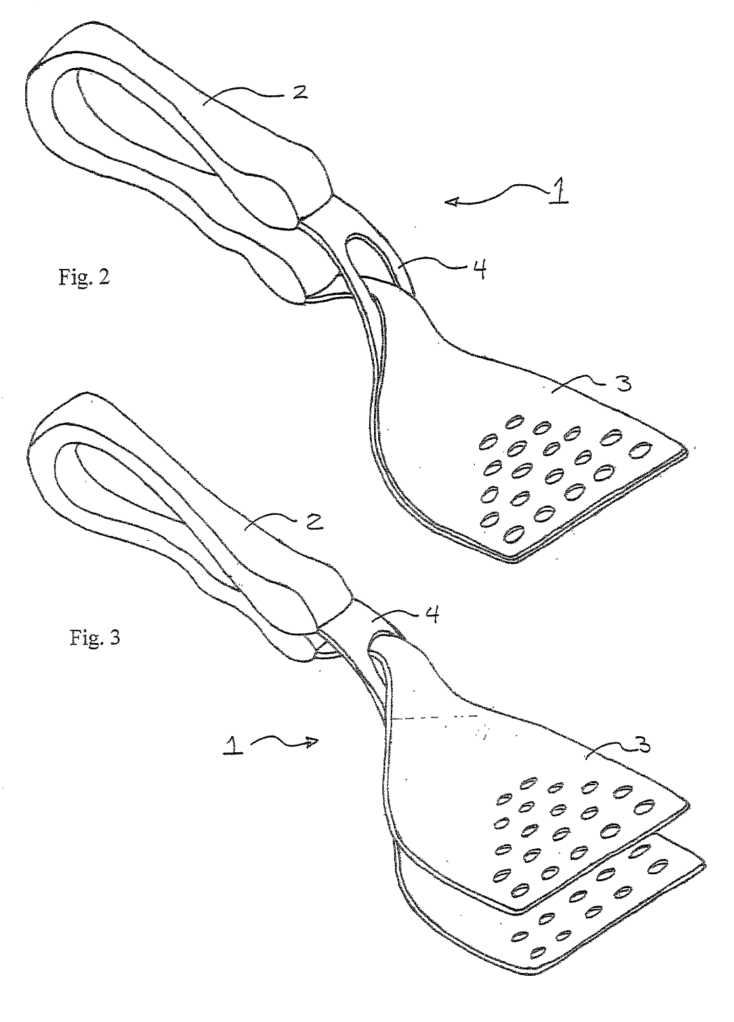

The handle should be made from a material with high tensile strength, stiffness, resilience, fatigue/compression endurance and low heat conductivity such as a homopolymer, polyamide or polyurethane or other materials used for comparable cooking tools, and could be coated with a material such as a thermoplastic elastomer for added grip and comfort. The jaws may be made of a heat resistant plastic such as a polyamide, metal or from other suitable materials such as those used in similar cooking utensils. As shown in FIG. 2, the cooking tool 1 has a handle 2, and two jaws 3 and 4. In one particularly preferred embodiment, jaw 3 passes through jaw 4 then connects to handle 2. When the jaws 3 and 4 are closed, handle 2 is in its open position; jaw 3 presses against jaw 4 in substantially parallel contact. This position is the natural resting position of the tool.

As illustrated in FIG. 3 when jaws 3 and 4 are open, handle 2 is in its closed position; jaw 3 is separated from jaw 4. This position is caused by compressing handle 2.

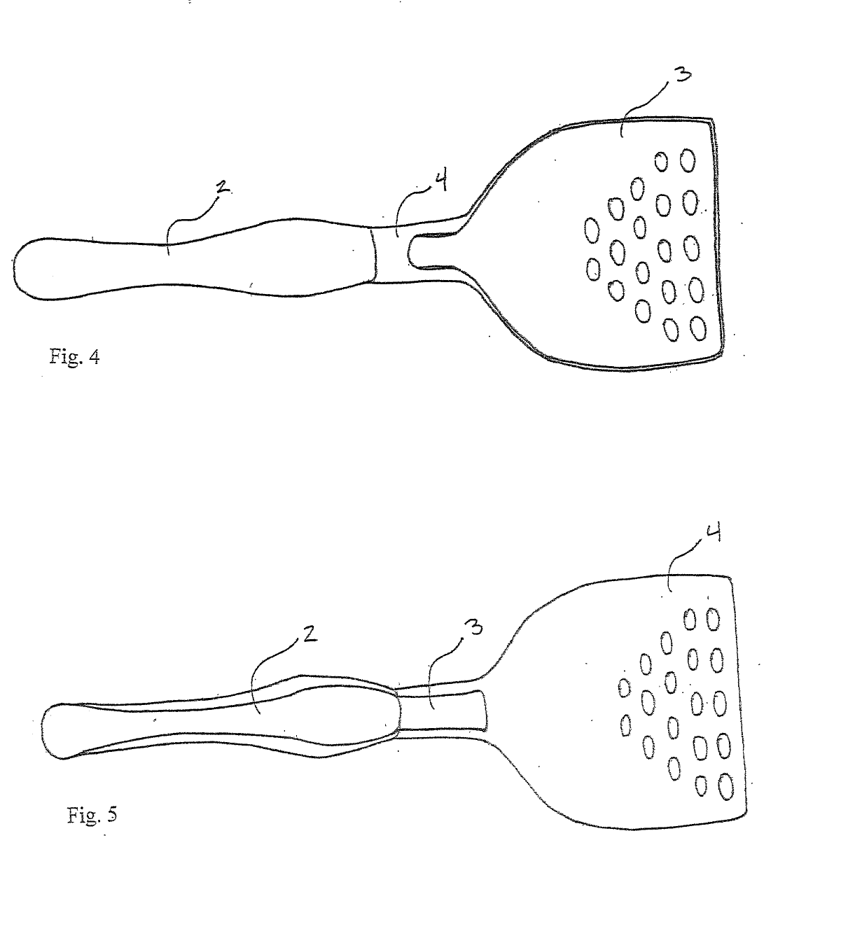

In FIG. 4 the top of tool 1 can be seen with its handle 2, and jaws 3 and 4.

In FIG. 5 the bottom of tool 1 can be seen with its handle 2, and jaws 3 and 4.

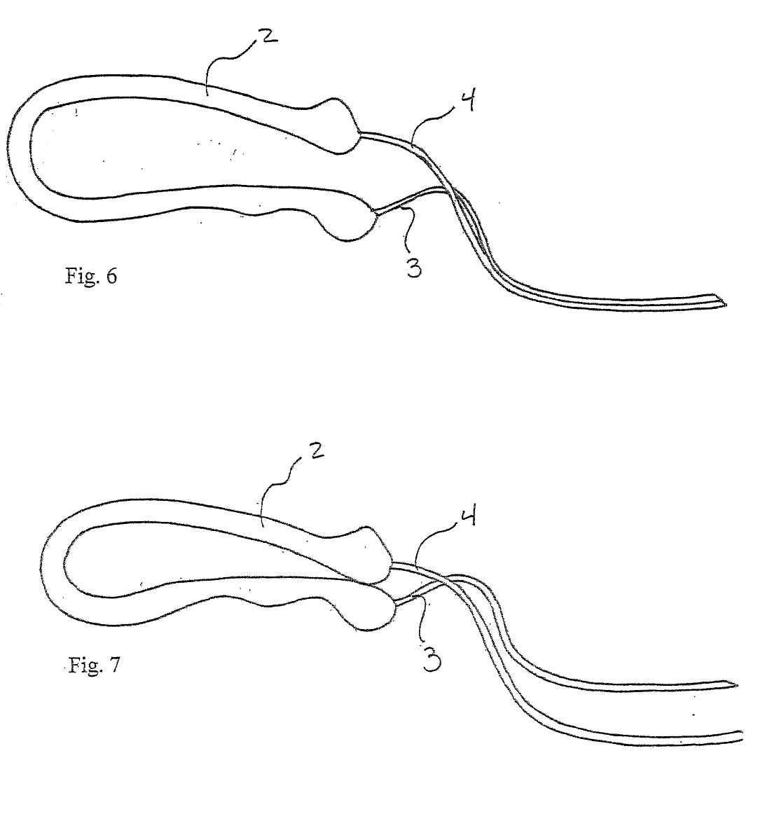

FIG. 6 shows the side of tool 1 in the resting position with jaws 3 and 4 closed. When jaws 3 and 4 are closed, handle 2 is in its resting position. Handle 2 connects to jaws 3 and 4.

FIG. 7 shows the side of tool 1 with jaws 3 and 4 opened. When handle 2 is compressed, jaws 3 and 4 are forced to open. Handle 2 connects to jaws 3 and 4.

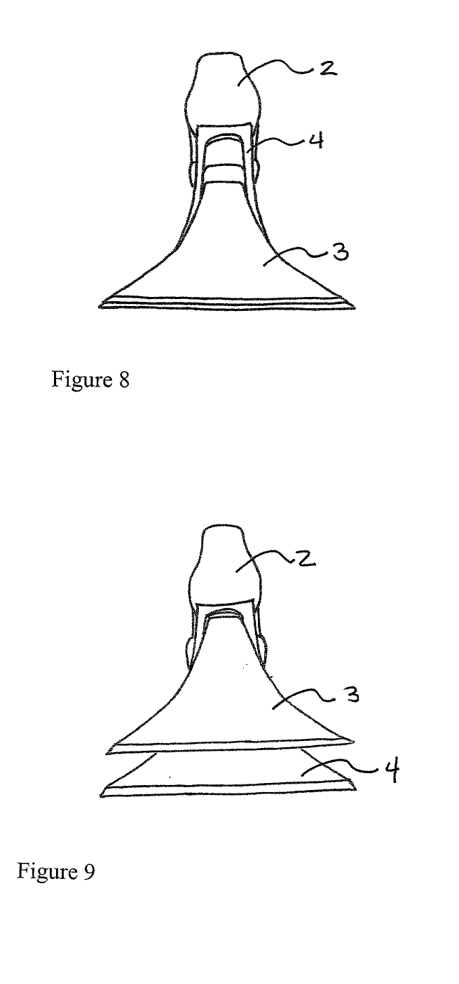

FIG. 8 shows the front of tool 1 with jaws 3 and 4 closed. When jaws 3 and 4 are closed, handle 2 is in its resting position. Handle 2 connects to jaws 3 and 4.

FIG. 9 shows the front of tool 1 with jaws 3 and 4 opened. When handle 2 is compressed, jaws 3 and 4 are forced to open. Handle 2 connects to jaws 3 and 4.

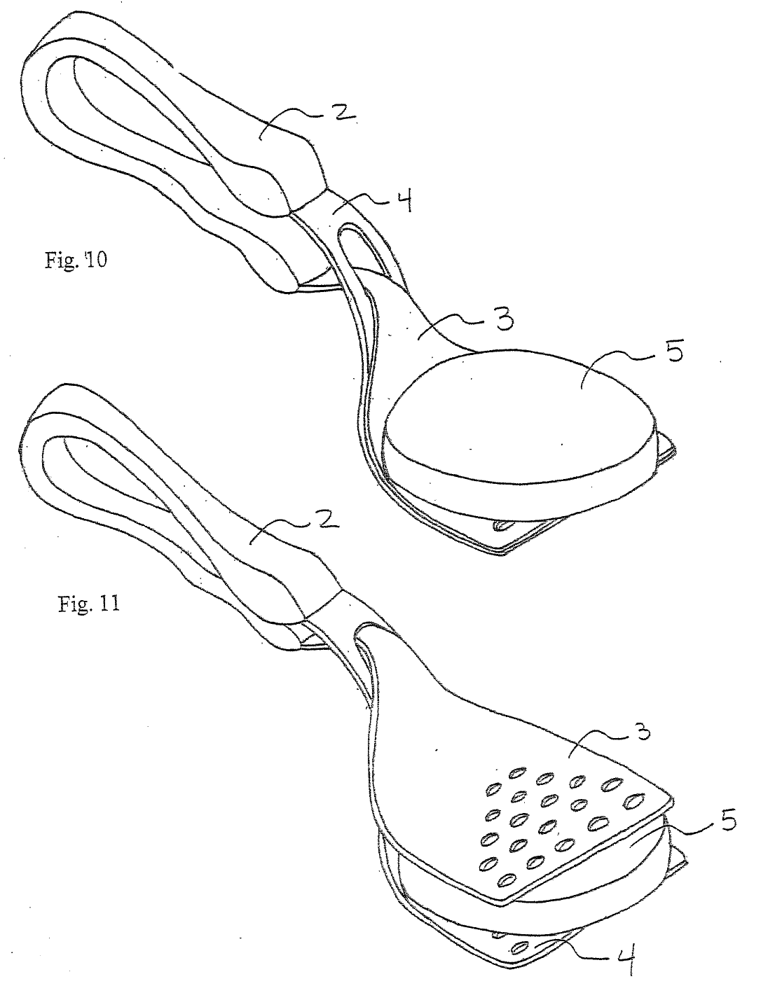

FIG. 10 shows cooking tool 1 in use with closed jaws 3 and 4 connected to handle 2 while scooping food 5. Food 5 is in contact with jaw 3. Handle 2 is in the uncompressed or resting position.

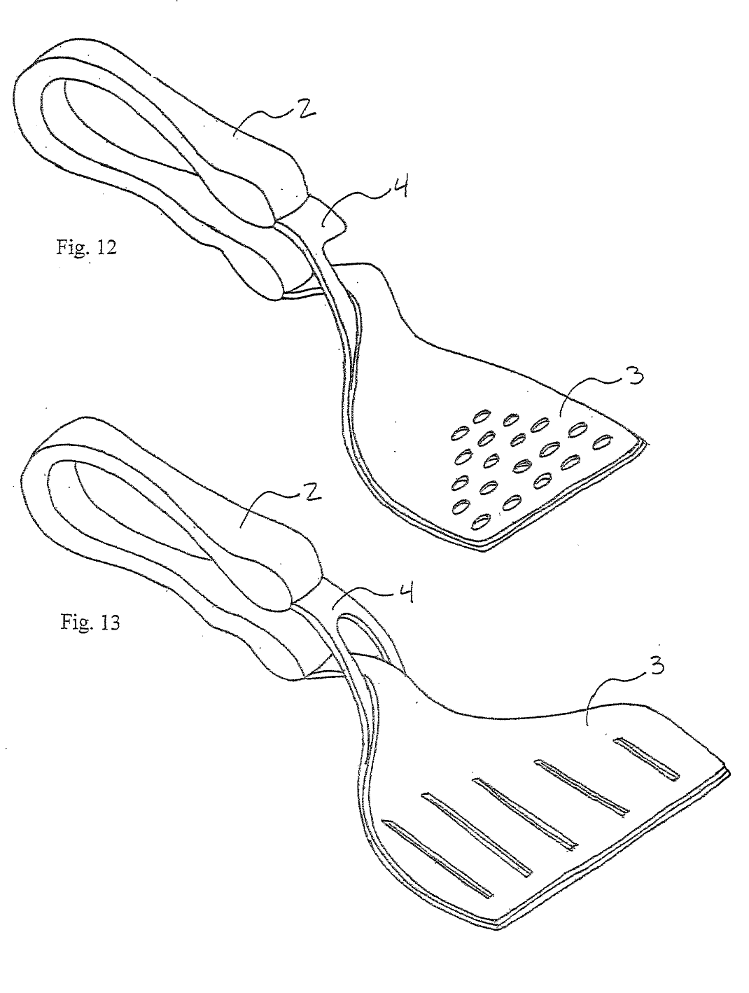

FIG. 11 shows cooking tool 1 in use with food 5 between jaws 3 and 4, which are connected to handle 2. Food 5 is in contact with jaw 3 and 4. Handle 2 acts as a spring to squeeze jaw 3 and 4 towards each other in order to hold food 5.

FIG. 12 shows a further embodiment in which handle 2 is connected to jaw 3 and 4. In this embodiment jaw 3 does not pass through jaw 4, instead jaw 3 passes next to jaw 4. In this embodiment, jaw 3 can be moved to the side and down past jaw 4 such that jaw 3 becomes the lower jaw and jaw 4 becomes the upper jaw. This alternate embodiment allows the user to convert the device into one which functions as an ordinary pair of tongs, should the need arise. This embodiment also simplifies cleaning of the device.

FIG. 13 shows a further embodiment in which jaws 3 and 4 are of a different shape and are connected to handle 2. This embodiment of the device would be appropriate for flipping large foods such as an omelet.

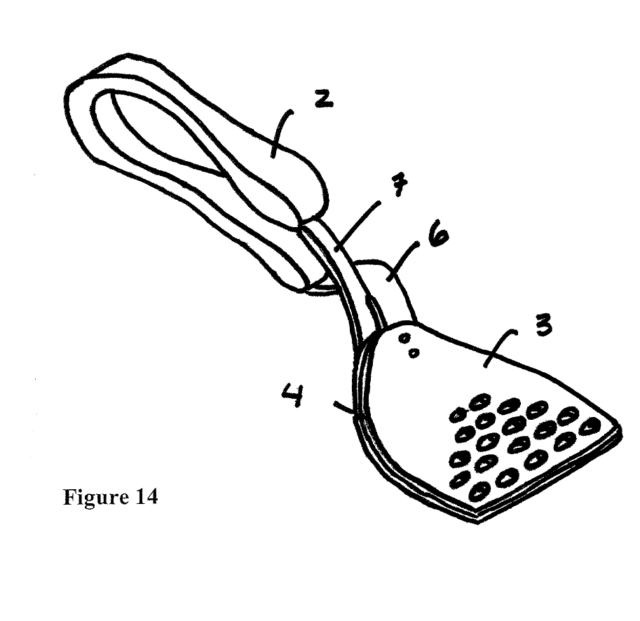

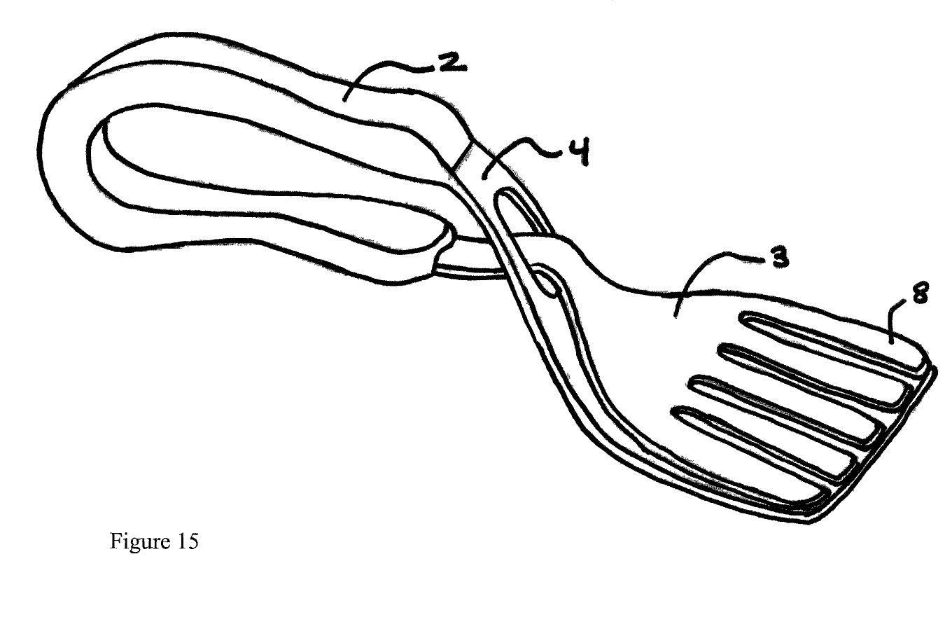

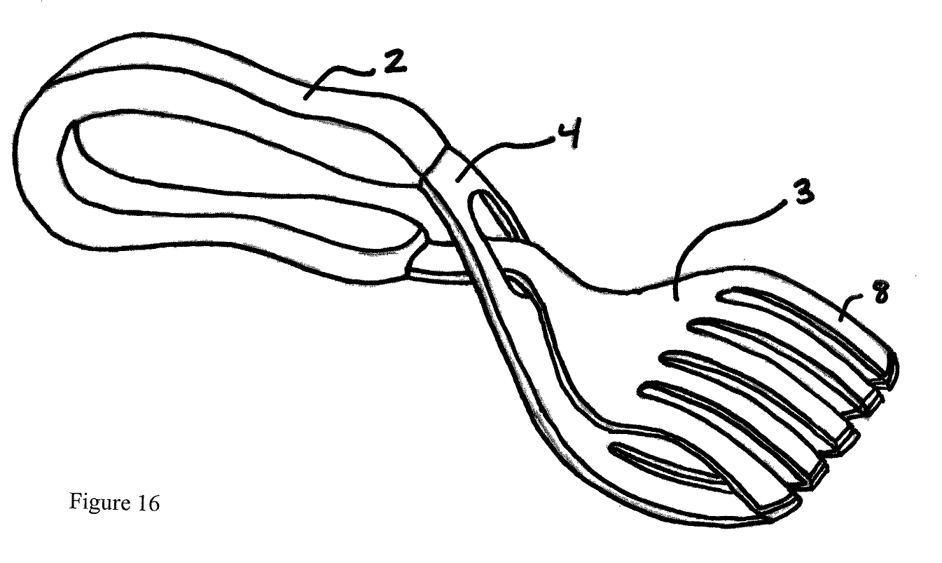

FIG. 14 shows an alternate embodiment of the present invention in which necks 6 and 7 of jaws 3 and 4 slide past one another. Necks 6 and 7 come out of handle 2 and are connected to jaws 3 and 4.

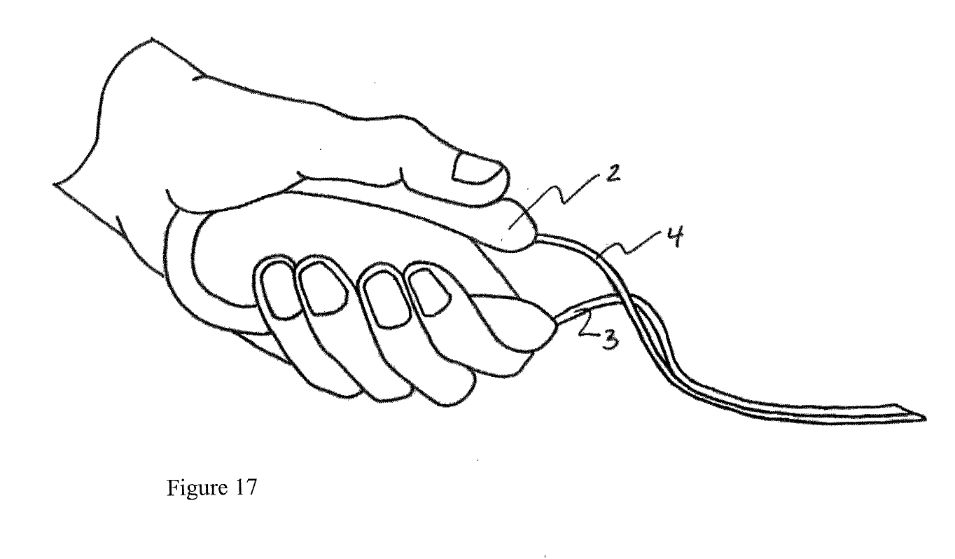

FIG. 15 shows a further embodiment in which jaws 3 and 4 have tines 8.

FIG. 16 shows a further embodiment in which jaws 3 and 4 are bent such that the tips of jaws 3 and 4 meet while the remaining portions of jaws 3 and 4 are oppositely curved such that there is a distance between the internal portions of jaws 3 and 4. Jaws 3 and 4 of this embodiment may further include tines 8.

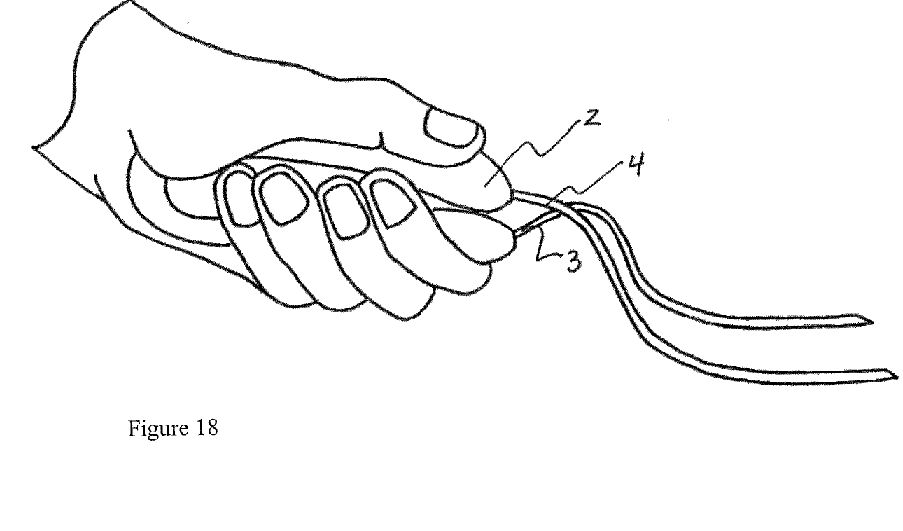

FIGS. 17 and 18 show the present invention in use. FIG. 17 shows the cooking device being held by a user with the handle 2 in the uncompressed state. Jaws 3 and 4 are in contact with each other and the device can be used as a spatula. FIG. 18 shows the device being held by a user with the handle 2 in the compressed state. Jaws 3 and 4 are separated from one another and the device can be used to grasp food as shown in FIG. 11.

Many improvements, modifications, and additions will be apparent to the skilled artisan without departing from the spirit and scope of the present invention as described herein and defined in the following claims.

What is claimed is:

1. An improved cooking device, comprising:
an upper jaw having proximal and distal ends;
a lower jaw having proximal and distal ends;
a handle connected to the proximal ends of the upper and lower jaws and connecting the upper and lower jaws, the handle being spring biased such that the upper and lower jaws are in substantially parallel contact with each other and such that a compression force on the handle causes the upper and lower jaws to separate from each other.

2. The cooking device as set forth in claim 1 wherein the upper and lower jaws are substantially planar in configuration.

3. The cooking device as set forth in claim 1 wherein the upper and lower jaws are made from a material selected from the following group: heat resistant plastic or metal.

4. The cooking device as set forth in claim 1 wherein the upper and lower jaws include drainage holes.

5. The cooking device as set forth in claim 1 wherein the distal end of the upper jaw is divided into tines which are biased into substantially parallel contact with the lower jaw by the handle.

6. The cooking device as set forth in claim 1 wherein the distal ends of the upper and lower jaws are divided into tines and which jaws are biased into substantially parallel contact with each other by the handle.

7. The cooking device as set forth in claim 1 wherein the distal ends of the upper and lower jaws are divided into curved tines such that portions of the tines most distant from the handle are in contact and such that the remaining portion of the tines on the upper and lower jaws curve away from each other.

8. The cooking device as set forth in claim 1 wherein the handle is made from a material selected from the following group: homopolymer, polyamide or polyurethane.

9. The cooking device as set forth in claim 1 wherein the handle is coated with a thermoplastic elastomer.

10. The cooking device as set forth in claim 1 wherein the handle is releasably connected to the proximal ends of the upper and lower jaws such that either of the upper and lower jaws can be removed and replaced with an alternate jaw.

11. The cooking device as set forth in claim 1 wherein the handle is releasably connected to the proximal ends of the upper and lower jaws such that both of the upper and lower jaws can be removed and replaced with alternate upper and lower jaws.

12. An improved cooking device, comprising:
an upper jaw having a planar configuration with proximal and distal ends, and made from a heat resistant material;
a lower jaw having a planar configuration with proximal and distal ends, and made from a heat resistant material;
a handle connected to the proximal ends of the upper and lower jaws and connecting the upper and lower jaws, the handle being spring biased such that the upper and lower jaws are in substantially parallel contact with each other and such that a compression force on the handle causes the upper and lower jaws to separate from each other, the handle further being made from a heat resistant material.
